(19) United States
(12) Patent Application Publication
(10) Pub. No.: US 2006/0101621 A1
(43) Pub. Date: May 18, 2006

(54) Magnetic bookmark utilizing built-in fulcrum and levers

(76) Inventor: George J. Just, Chicago, IL (US)

Correspondence Address: GEORGE J. JUST, SUITE 102, 2126 N. SAWYER AVE., CHICAGO, IL, 60647, US

(21) Appl. No.: 11/323,923

(22) Filed: Jan. 3, 2006

Related U.S. Application Data
(62) Division of application No. 09/982,455, filed on Oct. 23, 2001.

(51) Int. Cl. B42F 1/00

(52) U.S. Cl. 24/67 R

(57) ABSTRACT

A magnetic clip comprising a combined magnetic member/firm plate unit (34) lever, an opposing ferric armature member (22) lever, and attachment means (26) which hingedly connect said opposing levers. The lower proximal edge of said magnetic member serves as a fulcrum (44) about which said two levers can be pivoted by the operator's fingers of only one hand which can raise or lower portions (52), (56), (54), and (58) thereby causing the leading edges of said clip to open or close as needed to secure or release said bookmark to or from a sheet (30).

This document is a division of Ser. No. 09/982,455, Filed Oct. 23, 2001.

### BACKGROUND—FIELD OF INVENTION

This invention relates to magnetic clips, specifically to an improved construction of magnetic clips which are user friendly because they have fulcrum and lever controls built into them which enable an operator while using only one hand to place or remove the magnetic clip onto or off of a particular location on a sheet or set of stacked sheets in a book.

### BACKGROUND—DESCRIPTION OF PRIOR ART

Several magnetic clips are known which can be attached to a set of object or objects, such as a book sheet or sheets. These known magnetic clips and my invention have several structural and functional characteristics in common. At a particular location on a sheet or clamped group of sheets several of these known magnetic clips and my invention magnetically and frictionally clamp or unclamp that sheet or group of sheets between two opposing magnetically attracted members held in a face to face parallel alignment by magnetic attraction.

When the fabricator of my preferred embodiment or its prior art equivalent anticipates that the operator will need to grasp several sheets of paper simultaneously the fabricator will allow sufficient slack portions of the attachment means in the hinge fold area so the slack portions can be vertically expandable enough to allow the grasped set of article or articles to force the slack attachment means sections to expand vertically to create the vertical space needed to house the volume of space required by the varying vertical dimensions of the grasped set of multiple sheets.

The attachment means has an intrinsic ability to automatically return an open magnetic clip to a previously aligned closed position because the attachment means can be constructed out of a wide variety of flexible materials, such as paper, rubber, leather, plastic, and various impregnated fibrous material, many of which have an intrinsic ability after a few foldings to imprint a memory within their own affected molecular structure of where the hinge had previously been folded and therefore a proclivity to automatically return to the same aligned closed position from an open position with little or no guidance from the operator's digits; and

All of the previous magnetic clips heretofore known suffer from a number of disadvantages:
A) One negative characteristic that most of these known magnetic clips share, but my invention does not, is that when both opposing firm structure members are held in a face to face parallel alignment along a major planar surface of each member by magnetic attraction, before being attached to a sheet or set of stacked sheets, the magnetic bond which holds the distal sections of each element to its opposing member is difficult to disengage with only one hand. The opposing magnetically attached elements should be quickly separable at their leading edges so that each opposing element can be easily placed on either side of the targeted sheet, and at a particular location on the sheet. When the opposing members are reunited with each other the magnetic bond will be reestablished and the clip will have gained a significant purchase upon the targeted sheet so that a significant remainder of both opposing elements can be simultaneously slid inwards on either side of the targeted location on a sheet of paper and thereby become securely attached to the sheet at that location.
B) Worse yet, on many prior art magnetic clips, the magnetic bond is frequently so strong between the opposing members that the separation of the leading edges of the opposing members from each other absolutely requires manipulation by digits from two hands to break the magnetic bond holding the opposing members to each other. After separation it is sometimes possible for the operator to position the opposing clip members on either side of the targeted set of object or objects using the digits of one hand, but more often the digits of both hands will be needed. Frequently, considerable further digital manipulation of the clipping device is required from dexterous fingers to finally move the clip's opposing members towards each other until they are again magnetically bonded to each other and now frictionally retain the targeted sheet or set of stacked sheets between the clip members. Handicapped persons with even a slight lack of digital motor skills find prior art magnetic clips difficult to manipulate.
C) Inventors of other known magnetic clips concentrated mainly on establishing that magnetic clips containing thin magnetically bonded plates could well perform the role of frictionally retaining a sheet or set of stacked sheets between two opposing magnetically bonded thin plates. The concept of using a lever and fulcrum that is actually built into a thin magnetic clip to help separate the leading edges of opposing plate members from each other has not been known in the art of creating magnetic clips prior to this invention.
D) Many prior art magnetic clips require that specific polarities be imposed upon a magnetic member so it can be properly mated to a facing oppositely polarized magnetic member and thereby achieve their magnetic bond. These prior art clips need magnets whose polarity configurations are sensitive and critical so that they are expensive to fabricate in-house and even more expensive to purchase on the open market. U.S. Pat. No. 5,103,756 to Korkames (1992), U.S. Pat. No. 4,258,493 to Kettlestrings (1981), and U.S. Pat. No. 4,255,837 to Holtz (1981), all specify that opposing magnets are needed, and that opposite poles face opposite one another. All these magnetic clips are more difficult to operate with one hand than mine is, as are the magnetic clips seen in U.S. Pat. No. 2,713,844 to Mueller (1955), and U.S. Pat. No. 2,448,611 to Martin (1948). However prior art magnetic clips can be useful when teaching magnetism, since they can be used to demonstrate the concrete object lesson that magnets with multiple opposing polarities can be attracted to each other along all the opposing polarities. My embodiments also can be fabricated to teach this concrete object lesson since all of my embodiments, including the preferred embodiment, can be fabricated so that an armature member (22) lever when constructed of a firm magnetic member lever with oppositely polarized magnetic domains to that of the magnetic domains of the magnetic member (20) lever can be substituted for the ferric armature member (22) lever specified in all of my embodiments.
E) In the majority of usage events the skilled operator will prefer to maximally insert the magnetic clip so that its fold directly abuts the edge of the targeted sheet. While using the prior art clips to abut the sheet's edge with the attachment means's fold the operator would have to slide 90%+ sections of the inside surfaces of both opposing elements of the clip over and under the surfaces of the targeted sheet until sheet-edge to attachment-means-fold abutment occurs. In the same situation my clip with a lever and fulcrum will require only the sliding of those inside surface sections of the clip which are located proximally to the fulcrum, about 12% of the entire average device, to be easily slid over and under the surfaces of the targeted sheet until the sheet-edge to attachment-means-fold abutment occurs. To abut the fold of prior art bookmarks with the edge of the targeted sheet usually requires the sliding of the prior art clip inwards and over and under the targeted sheet commencing at the very front of the clip and ending at the rear of the clip where the fold is constructed. Consequently, while using only the digits of one hand, 95% of the prior art's clip usually has to be slid inwards over and under the surfaces of the targeted sheet to achieve sheet-edge to attachment-means-fold abutment whereas only 12% of my clip has to be slid inwards over and under the surfaces of the targeted sheet to achieve sheet-edge to attachment-means-fold abutment, all the while using only two fingers of one hand. The sheet-edge to attachment-means-fold abutment is desirable because this minimizes the inadvertent dislodging of the clip from its marked sheet, and because the less sliding of the device over a delicate sheet of paper the less chance that the sheet of paper will be wrinkled or torn during the clipping process.

### SUMMARY

In accordance with the present invention a magnetic clip comprises a built-in fulcrum strategically situated between built-in opposing magnet lever and keeper lever.

### OBJECTS AND ADVANTAGES

According, several objects and advantages of the present invention are:
A) The manufacturing and assembling process is much less expensive for my main embodiment than for prior art clips because:
   1) Several of my embodiments use a detachable magnetic member lever magnetically bondable to a ferric armature member lever to accomplish the magnetic bonding function but at a very much lower cost in materials and at an extremely lower cost of assembling of the device because precautions necessary for precisely matching opposite polarized magnetic members is obviated when the armature member lever is a non-magnetized ferric plate lever.
   2) My main embodiment can utilize any predeterminingly dimensioned magnetic member (20) lever providing it is of sufficient thickness so that one of its edges can serve as a fulcrum (44) as shown in FIG. 1E.
   3) My device can use any predeterminingly sized permanent magnetic member lever with the correct magnetic reach-out product which can easily be calibrated by the designer.
   4) Most of my embodiments can be inexpensively fabricated into various shapes, rectilinear, circular, oblong, triangular, multiply vertexed, even 3-dimensional, especially in bas relief.
B) Skilled operators prefer to use a lever and fulcrum enhanced magnetic clip which requires less sliding over and under the targeted sheet as it is being attached to the sheet or sheets with the use of two or more digits of one hand than the prior art clips require. My clip is user friendly since it saves operator's time, mental energy, motion, and money.
C) My leading edges always separate from each other when only slight digital pressure is applied upwards or downwards as desired to the proximal section of either lever located to the rear of the fulcrum using only the digits of one hand. When it is desirable to clip one sheet or even several stacked sheets at one time it helps to have leading edges on the clip that can be easily separated with the aid of an inbuilt lever and fulcrum
D) While being easily operated with only the digits on one hand my clip requires minimal sliding over and under the targeted sheet while being attached to the perimeter of a very thin sheet of paper and hence will lower the incidence of wrinkling of the targeted thin sheet. When prior art clips are operated with one hand or even two hands they often require inward sliding of the opposing elements over and under the targeted surfaces of a thin sheet right from the tip of the clip's leading edges to the proximal edges of the opposing elements thereby increasing the risk of wrinkling the sheet.

### DRAWING FIGURES

In the drawings, closely related figures have the same number but different alphabetic suffixes.

FIG. 1A shows a life size left orthographic view of a closed magnetic clip embodiment.

FIG. 1B shows a life size left isometric view of said magnetic clip shown in FIG. 1A.

FIG. 1C shows an enlarged left isometric view of said magnetic clip shown in FIG. 1B.

FIG. 1D shows an enlarged left side orthographic view of the magnetic clip shown in FIG. 1A.

FIG. 1E shows an enlarged open position left orthographic view of same magnetic clip shown in FIG. 1A.

FIG. 1F shows an exploded isometric view of all four parts of the magnetic clip shown in FIG. 1A.

FIG. 1G shows a life size left orthographic view of a magnetic clip invention similar to said FIG. 1A except that the attachment means has been removed.

FIG. 1H shows a life size left isometric view of same magnetic clip invention illustrated in FIG. 1G.

FIG. 1I shows an enlargement of the left orthographic view of the magnetic clip shown in FIG. 1G.

FIG. 1J shows an enlarged open position left orthographic view of the magnetic clip shown in FIG. 1G.

FIG. 1K shows an enlargement of left orthographic view of combined magnetic member/firm plate unit (34).

FIG. 1L shows an enlarged left isometric view of same magnetic clip shown in FIG. 1G whose leading edges are elevated away from each other.

FIG. 2A shows a life size left orthographic view of another embodiment of this magnetic clip invention.

FIG. 2B shows an enlarged left isometric view of magnetic clip shown in FIG. 2A.

FIG. 2C shows an enlargement of orthographic view of magnetic clip shown in FIG. 2A but in the open position.

FIG. 2D shows a closed life size left orthographic view of a similar magnetic clip as the magnetic clip embodiment seen in FIG. 1A. FIG. 2D does not have the attachment means that FIG. 1A does.

FIG. 2E shows a life size left isometric view of said FIG. 2D magnetic clip in the open position.

FIG. 2F shows an enlargement of said FIG. 2D.

FIG. 2G shows an enlarged left orthographic view of FIG. 2D magnetic clip whose opposing levers are elevated away from each other and whose opposing levers are dwellingly poised on site sides of a targeted sheet of paper.

FIG. 2H shows an enlarged open position left isometric view of said FIG. 2F.

### REFERENCE NUMERALS IN DRAWINGS

20 magnetic member 54 load at proximal portion of armature
22 armature member member
24 firm plate 56 load at distal portion of combined
26 attachment means magnetic member/firm plate unit
30 targeted sheet 58 load at distal portion of armature
34 combined magnetic member/firm plate member unit 60 beveled edge
36 location where portion of one opposing 62 proximal end of magnetic member finger is pressed inwardly at a point on 64 portion of one opposing finger is the magnetic member's outer surface pressed inwardly at a point on the that is proximal to the fulcrum magnetic member's outer surface that
37 location where portion of one opposing is distal to fulcrum finger is pressed inwardly at a point on 65 portion of one opposing finger is the combined magnetic member/firm pressed inwardly at a point on the plate unit's outer surface that is combined magnetic member/firm plate proximal to the fulcrum unit's outer surface that is distal to
38 distal end of magnetic member fulcrum
44 fulcrum 66 portion of one opposing finger is
50 load at proximal portion of magnetic pressed inwardly at a point that is member distal to the fulcrum on the armature
51 load at distal portion of magnetic member's outer surface member 67 portion of one opposing finger is
52 load at proximal portion of combined pressed inwardly at a point that is magnetic member/firm plate unit proximal to the fulcrum on the armature member's outer surface towards fulcrum for control purposes
68 section of armature member opposing 74 hinge fold area magnetic member's slanted surface 80 major outer planar surface of armature
70 approximate point, on magnetic member, per se, or of armature member, opposite fulcrum, where member with attachment means finger pressure is applied inwardly on adhered to it magnetic member's outer surface 82 distal leading end of armature member towards fulcrum for control purposes 86 distal (leading) end of magnetic member
72 approximate point, on armature
90 major outer planar surface of magnetic member, opposite fulcrum, where member lever, or of combined finger pressure is applied inwardly on armature member's outer surface magnetic member/firm plate unit armature member's outer surface

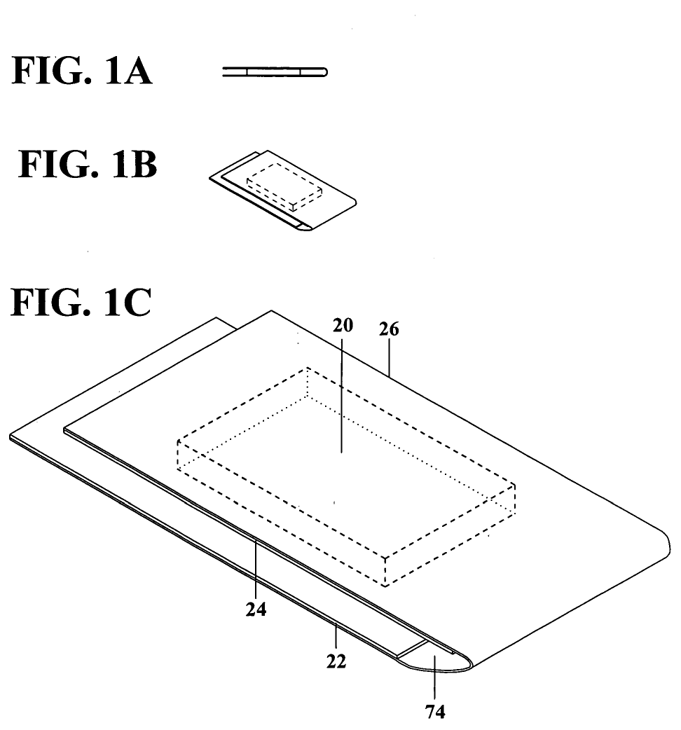

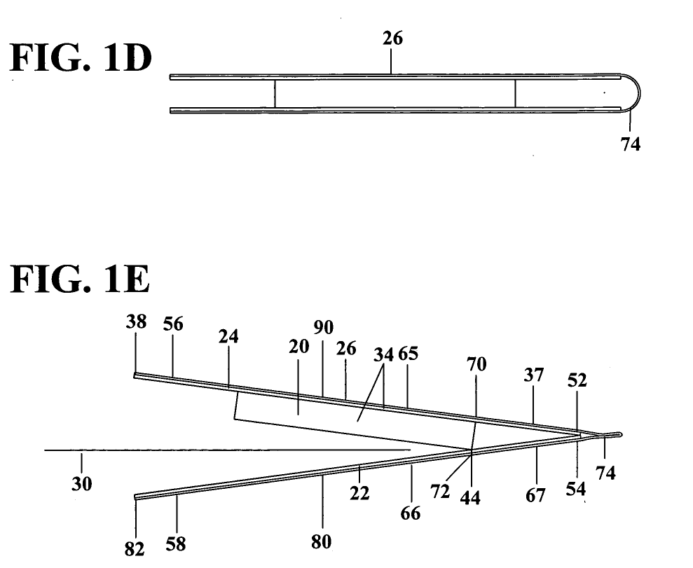

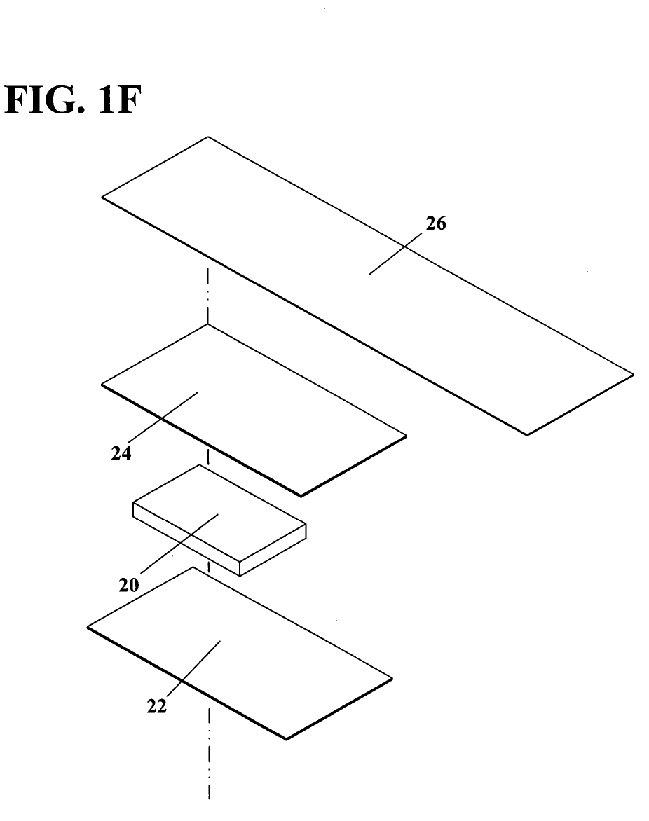

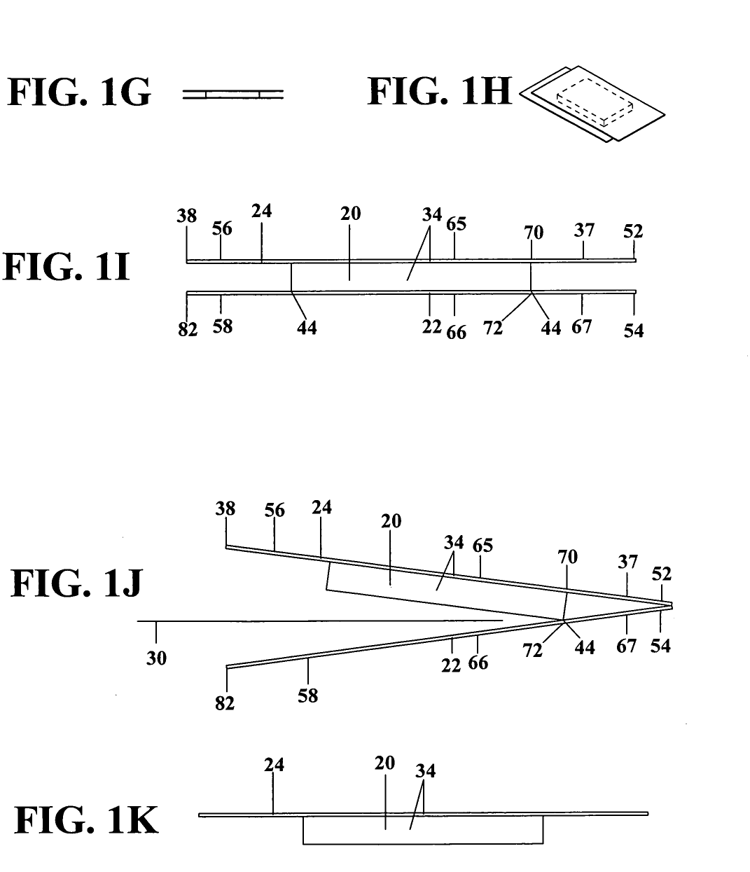

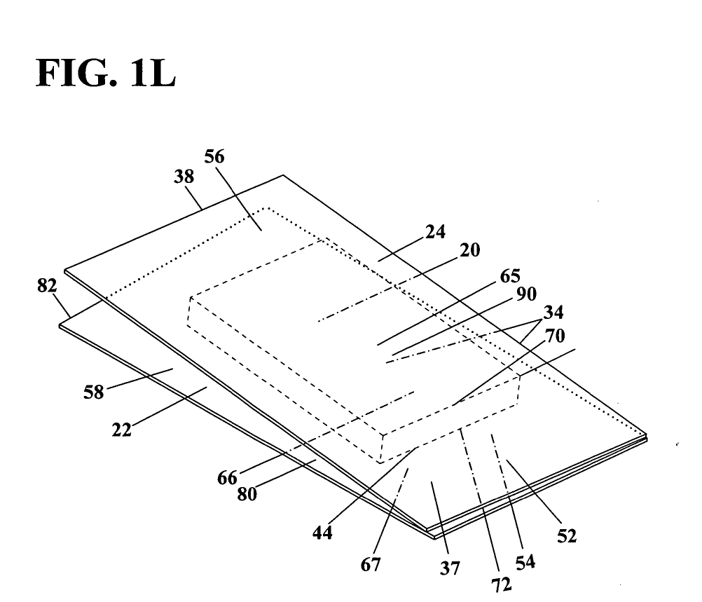

### DESCRIPTION—FIGS. 1A, 1B, 1C, 1D, 1E, AND 1F—

### Preferred Embodiment

FIG. 1F shows an exploded view of this preferred embodiment illustrating the attachment means (26), the firm plate (24) lever, the magnetic member (20) lever, and the armature member (22) lever. In the preferred embodiment the attachment means and the flexible film wrapping are made of Stevens polyurethane film available from STEVENS Elastomerics, Northampton, Mass. Typically the attachment means is comprised of a 0.004″ to 0.008″ thickness layer with the smaller size preferred. A bookmark clip would require the smaller thickness. The attachment means can consist of any other material that can be repeatedly flexed and unflexed 90° or more without tearing, such as polyethylene, polypropylene, nylon, rubber, leather, fabrics, cardboard, paper, etc. The firm plate (24) lever, and the armature member (22) lever is typically a 0.007″ thick ferric tin plate available from many hardware stores or sheet metal shops. The preferred embodiment can be fabricated so that an armature member (22) lever constructed of a firm magnetic member lever with oppositely polarized magnetic domains to that of the magnetic domains of the magnetic member (20) lever can be substituted for the ferric armature member (22) lever specified in my main embodiment. The magnetic member (20) lever could be comprised of any permanent magnet of the right size for the job even up to more than a one inch thickness.

The preferred embodiment as shown in FIGS. 1A and 1B is typical of a small bookmark on which graphic images can be printed on all viewable surfaces, and has these dimensional characteristics: The attachment means (26) is large enough to hingedly connect said magnetic member and said armature member. Both the firm plate (24) lever, and the armature member (22) lever have similar length, width and thickness dimensions. The magnetic member (20) lever is smaller than the length and width dimensions of said firm plate (24) lever and said armature member (22) lever. Said magnetic member is overlapped by both said firm plate and said armature members and provides a fulcrum (44) between said armature member and said firm plate.

The magnetic member (20) lever is attached in a coaxial alignment to the firm plate (24) lever. This combination is called the combined magnetic member/firm plate unit (34) lever, see FIG. 1K.

Next the attachment means (26) is folded along its lateral axis at a point that is equally distant from the distal edge of the attachment means, and from the proximal edge of the attachment means. The combined magnetic member/firm plate unit (34) lever, and the armature member (22) lever are mounted under the fold at opposite ends of the attachment means. The area around the fold which is not adhered to either opposing clip member is called the hinge fold area (74).

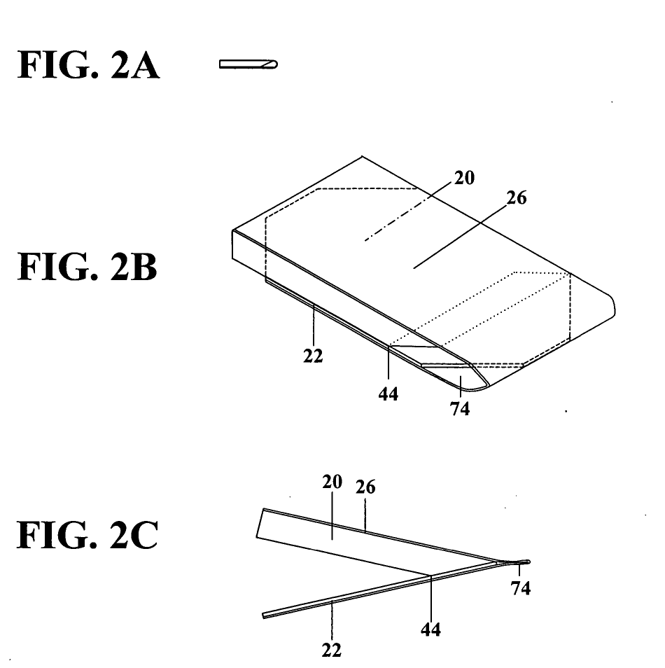

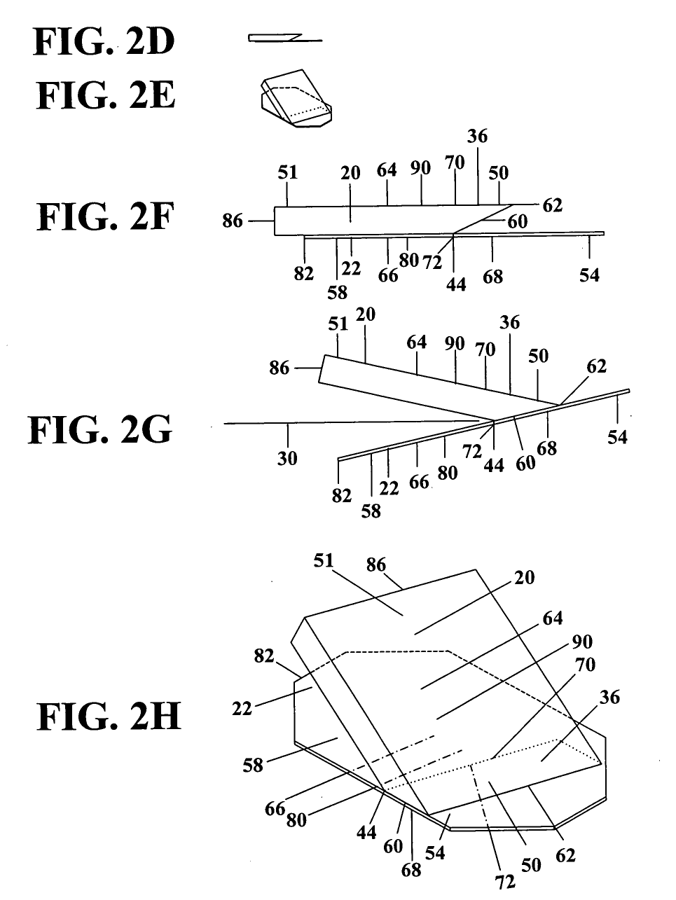

### DESCRIPTION—FIGS. 1G, 1H, 1I, 1J, 1K, 1L, 2A, 2B, 2C, 2D, 2E, 2F, 2G, AND 2H—

### Additional Embodiments

FIGS. 1G, 1H, 1I, 1J, and 1L show an additional standalone embodiment that has a similar kinds of fulcrum, and similar types of levers as does the preferred embodiment: It has a magnetic member (20), strategically placed between armature member (22) lever, and firm plate (24) lever. Like the preferred embodiment the embodiment requires that a fulcrum be constructed strategically between two levers.

FIGS. 1G, 1H, 1I, 1J, and 1L show a simple standalone embodiment where the attachment means of the main embodiment have not been attached, and where the three discrete pieces which comprise this standalone embodiment are similar to the three elements that comprise the core of the preferred embodiment in composition, structure, and dimensions: the magnetic member (20) lever, the armature member (22) lever, and the firm plate (24) lever.

FIGS. 2D, and 2E show another life sized standalone embodiment of the magnetic clip of the present invention in 2 different views. Enlargements of FIGS. 2D, and 2E of the standalone embodiment of the magnetic clip of the present invention is illustrated in FIGS. 2F, and 2H indicating the fulcrum (44), the magnetic member (20) lever which opposes the armature member (22) lever, and the four potential loads (50), (51), (54), and (58). FIGS. 2F, and 2H, show that the magnetic member (20) lever, has a beveled edge (60) which extends laterally completely across the short side of the magnetic member lever, and is cut into the section of the magnetic member lever which faces the opposing armature member (22) lever. The angle of inclination of the inner vertex of the bevel in FIG. 2F starts at the 25.7° angle where the inner vertex (44) of the bevel on the magnetic member lever meets the armature member lever. The bevel terminates at the proximal end of magnetic member (62) lever, the outer vertex of the bevel. The cutting of the inner vertex (44) which serves as a fulcrum on the beveled edge (60) can start at any angle of inclination that is needed to produce a usable fulcrum and levers and can terminate at any location that will permit the functioning of a fulcrum and levers. As shown in FIG. 2F, just before operation of this embodiment the magnetic member (20) lever is aligned with the armature member (22) lever in face to face parallel alignment along their major planar surfaces so that the bevel's inner vertex portion can serve as a fulcrum because a predetermined portion of the opposing armature member lever will be large enough to serve as an opposing platform upon which the fulcrummed vertex can be pivoted. Typically, in a magnetic clip embodiment designed to yield a small footprint the two opposing elements have approximately these life size length×width×thickness dimensions: The magnetic member (20) lever is 0.5×0.3125×0.06 inches, and the armature member (22) lever is 0.5×0.3125×0.007 inches. This embodiment which is designed with small spatial dimensions will allow said embodiment to be securely attached to a page without inordinately enlarging and widening the interstitial spaces between the pages. Much depends upon the size of the magnetic member lever and the magnetic reach out strength of the magnet. FIG. 2H shows that the fulcrum (44) extends laterally completely across the short side of the magnetic member lever, and is located on the loci which also describe the lateral dimension of the inner vertex (44) of the beveled edge (60).

FIGS. 2F, 2G, and 2H show the six points, (64), (66), (36), (68), (70), and (72) where digital pressures are usually applied or released along the major outer surface of the magnetic member (90) lever, and the opposing armature member (80) lever to open or close the leading ends, and also show the four loads that can be turned about the fulcrum by the opposing magnetic and armature member levers (20), and (22) respectively. Load one (50) is the section of the magnetic member (20) lever that is proximal to the fulcrum. Load two (51) is the section of the magnetic member (20) lever that is distal to the fulcrum and which terminates at the leading end (86) of the magnetic member (20) lever. Load three (54) is the section of the armature member lever that is proximal to the fulcrum. Load four (58) is the section of the armature member lever that is distal to the fulcrum and which terminates at the distal leading end (82) of the armature member lever.

FIG. 2A shows another life sized standalone embodiment of the magnetic clip of the present invention which has the same two elements of FIG. 2D plus the addition of the flexible attachment means (26). FIG. 2B illustrates an enlarged left side isometric view of FIG. 2A and shows the flexible attachment means (26) which is adhered to the outer surfaces of the magnetic member (20) lever and its opposing armature member (22) lever so that a predetermined portion (74) of the flexible attachment means, usually located towards the center of the attachment means, is not secured to any part of the armature member (22) lever, or the magnetic member (20) lever. FIG. 2C shows an enlarged left side orthographic view of the standalone embodiment shown in FIG. 2A, and illustrates FIG. 2A embodiment in the open position.

### OPERATION—FIGS. 1A, 1B, 1C, 1E, AND 1F—

### Preferred Embodiment

Characteristic of the operation of all of the above drawn and described embodiments is the intuitive operation of the preferred embodiment because each and everyone of the above drawn embodiments utilizes a built-in fulcrum and opposing levers:
A) As can be ascertained in the preferred embodiment FIGS. 1B, 1C, and 1E, the manner of attaching the preferred embodiment to an unbound perimeter of a sheet of average thickness in a book or in a stack of sheets, is for the operator to grasp its magnetically closed parallel aligned levers along their major outer planar surfaces with the major inside surface areas of opposing fingers, usually the distal sections of the thumb and index digits of one hand. Each digit is aligned in the same elongate direction as the distal and proximal sections of each lever. Sections of each opposing fingers are then pressed inwardly with a predetermined squeezing force against six outer sections of each opposing lever: One: A section located on the magnetic member (20) lever at a point that is distal (65) to the fulcrum (44). Two: An opposing section on the armature member (22) lever located distally (66) to the fulcrum (44). Three and Four: Opposing sections on both levers that are located at points (70), and (72) that are located directly over and under the fulcrum (44), respectively. Opposing five and six: Opposing sections on both levers that are located at points (37), and (67) that are proximal to the fulcrum (44). Now the operator has grasped the magnetic clip and is in full control of it.
B) Next, the operator separates the distal ends (38), and (82) of the clip away from each other by increasing the opposing inward pressures being squeezed to the opposing sections (37), and (67) located proximally to the fulcrum (44) while simultaneously reducing or even completely stopping the opposing pressures being applied inwardly to the sections (65), and (66) located distally to the fulcrum. Consequently, the sections (52) and (54), of both levers that are located proximally to the fulcrum will swivel around the fulcrum and move towards each other. Simultaneously, the sections of both levers (56), and (58) that are located distally to the fulcrum will swivel around the fulcrum and move away from each other.
C) The operator then dwellingly poises the respective separated leading edges (38) and (82) of the clip on each side of a perimeter section of a targeted sheet (30) FIG. 1E. He then moves the poised separated leading edges inwardly on either side of the targeted perimeter section of the sheet until just before the fulcrum abuts the sheet's edge. At this point in time the operator can release his grasp on the opposed portions of both levers thereby usually allowing the opposing distal sections of both levers to automatically swivel around the fulcrum back towards each other and become magnetically bonded with each other and frictionally retain the targeted sheet between the opposing distal sections of the opposing device levers. If the distal section of a lever will not automatically swivel around the fulcrum and move back towards its opposing lever the distal section of said lever can be nudged towards its opposing lever by the digit which controls that lever.
D) To advance the fulcrum inwardly and over the sheet's edge the operator frequently has to lightly decrease the inward pressure being applied by his opposing digits to the proximal sections of the clip. He then usually pushes the clip inwards until a point on the attachment means hinge fold area (74) abuts the sheet's edge. When he has removed his digits from the clip the opposing distal sections of both levers will usually automatically swivel around the fulcrum back towards each other and become magnetically bonded with each other and frictionally retain the targeted sheet between the opposing distal sections of the opposing device levers. This automatic swiveling is created by the magnetic attraction of each lever towards its opposing lever which will help cause both levers to rotate back towards each other. Maintenance of a face to face parallel alignment of the opposing members is enhanced by the attachment means (26) which helps relegate each opposing lever to a predetermined face to face parallel aligned position, thereby reducing veering, yawing, and skewing of the opposing levers away from the predetermined perpendicular and horizontal central axes during operation.
E) The pressures from the opposing digits can be equally or unequally applied in thousands of combinations, resulting in the opposing levers becoming adequately separated from each other so they can be dwellingly poised on either side of a sheet or a set of 2 or more sheets in a book with accuracy. The operator can then secure the opposing levers to any targeted position on an unbound perimeter of the sheet that he desires.
F) The manner of attaching the clip to a targeted very thin sheet, easily torn, frequently involves utilizing a magnetic member whose magnetic strength is calibrated to a predetermined low enough magnitude so that while the operator is pushing the clip inwards to achieve an abutting of the clip's proximal edge with the sheet's targeted edge, the frictional resistance of the paper to the magnetically bonded opposing levers is maximally lowered. Also, the magnetic clip will only have to slide for that distance which is measured from the fulcrum to the most proximal abutting edge of the magnetic clip due to the initial opening of the distal ends of the magnetic clip with the aid of the fulcrum and the levers and the placement of the opposing levers of the magnetic clip on opposite sides of a targeted sheet until the sheet touches the fulcrum. The magnetic clip is then slid over the sheet until a point on the attachment means hinge area (74) abuts the sheet's edge. The less sliding the less chance of wrinkling or tearing a very thin sheet of paper. The strength of the magnetic member's magnetic reach out can easily be varied by the fabricator.
G) Texts and images can be imprinted advantageously on all viewable surfaces of the preferred embodiment, including flexible attachment means (26), firm plate (24) lever, magnetic member (20) lever, and armature member (22) lever.
H) The normal manner of removing the magnetic clip from its attachment to a sheet or set of sheets is to place the tips (distal sections) of the thumb and index fingers on opposite sides of the set of sheet or sheets and in front of the leading edges of the attached magnetic clip, and to slide the clip off the sheet.
I) Often the operator will want to remove the clip from its attachment to a particular location on the sheet and move the clip to another location on that same sheet. In this situation the operation will place the tips (distal sections) of the thumb and index fingers on opposite sides of the set of sheet or sheets and in front of the leading edges of the attached magnetic clip and slide the clip for a short distance off the perimeter of the sheet until the fulcrum point is removed from the sheet. The operator then uses the inside planar surfaces of two opposing digits on one hand, aligning the digits in the same elongate direction as each opposing lever is aligned and grasping the magnetically closed parallel aligned levers along their major outer surface areas (90), and (80) with the (major) inside surface planes of opposing fingers, usually the distal sections of the thumb and index fingers of one hand. Sections of each opposing fingers are then pressed inwardly with a predetermined force against four outside sections of the opposing levers: One: A section of predetermined size located on the combined magnetic member/firm plate unit (34) lever at a point that is distal (65) to the fulcrum (44). Two: An opposing section on the armature member (22) lever located distally (66) to the fulcrum (44). Three and Four: Opposing sections of predetermined dimensions on both levers that are located approximately at points (37), and (67) that are proximal to the fulcrum (44).
J) Next, the operator separates the distal ends of the clip away from each other by increasing the opposing inward pressures being applied to the sections located proximally to the fulcrum while simultaneously reducing the opposing pressures being applied inwardly to the sections distal to the fulcrum. Consequently, the sections of both levers that are located proximally to the fulcrum will swivel around the fulcrum and move towards each other. Simultaneously, the sections of both levers that are located distally to the fulcrum will swivel around the fulcrum and move away from each other. No part of the magnetic clip will now be grasping the sheet of paper and the operator can then dwellingly poise the separated opposing levers at another location on the same or other sheet and attach the clip to the targeted location or he can withdraw the clip completely away from the sheet should he have changed his mind about placing the clip on another location on this same sheet.
K) Preferred Embodiment Operation Summary: The operator's opposing fingers are able to apply squeezing forces to loads (52) and (54) or to loads (56) and (58) and cause the levers which comprise said four loads to move the portions of the magnetic device, that are located distally or proximally to the fulcrum, around the fulcrum, thereby creating an opening or closing of the leading edges, the distal sections of the device, as needed.

### OPERATION—FIGS. 2A, 2B, 2C, 2D, 2E, 2F, 2G, AND 2H—

### Alternative Embodiments

FIGS. 2A, 2B, 2C, 2D, 2E, 2F, 2G, and 2H illustrate a standalone embodiment which can be comprised of a very thin magnetic member opposing a very thin armature member so that the volume of interstitial spaces between pages occupied by the standalone embodiment is minimized, therefore, more of the standalone embodiment can be clipped to various different pages within the same book without causing the book's girth to widen and bulge out significantly. Hence the operator can utilize several magnetic clips during an operating event without significantly altering the book's physical conformation.

FIGS. 2A, 2B, and 2C illustrate a standalone embodiment which shows that when the magnetic member (20) lever, and the ferric armature member (22) lever are manipulated during the operation of shown standalone embodiment, maintenance of a face to face parallel alignment of the opposing members is enhanced by attachment means (26) which helps relegate each opposing lever to a predetermined face to face parallel aligned position, thereby reducing veering, yawing, and skewing of the opposing levers away from the predetermined perpendicular and horizontal axes during operation.

### OPERATION—FIGS. 1G, 1H, 1I, 1J, AND 1L—

### Alternative Embodiments

FIGS. 1G, 1H, 1I, 1J, and 1L show a standalone embodiment whose operation is very similar to the operation of the preferred embodiment in that both embodiments can serve as a standalone magnetic clip, but with the exceptions that the attachment means (26) have been removed from the FIG. 1A standalone embodiment, and since there is a fulcrum possibility (44) on both short side ends of the magnetic member (20) lever either short side end can function as the distal or proximal section of the magnetic clip during operation according to the needs of the operator, and during an operating event whichever side functions as the leading edge of the magnetic clip is called the distal section of the magnetic clip.

### CONCLUSION, RAMIFICATIONS, AND SCOPE

Although the description above contains many specificities, these should not be construed as limiting the scope of the invention but as merely providing illustrations of some of the present embodiments of this invention.
A) Any or all of the levers; the magnetic member lever, the armature member lever, or the firm plate lever can have other shapes, such as circular, oval, trapezoidal, triangular, etc.
B) The hinge fold area (74) of the attachment means can be extended so the magnetic clip can clasp as many sheets as the hinge area is designed to expand to, and the size and magnetic reach out strength of the magnet can grasp securely.
C) Any embodiment can have a ferric backup plate affixed to the outside surface of the magnetic member to increase the magnetic reach-out strength of the magnetic member.
D) The attachment means (26) will help relegate each opposing lever to a predetermined face to face parallel aligned position, thereby reducing veering, yawing, and skewing of the opposing levers away from the predetermined perpendicular and horizontal axes during operation.
E) Any of the shown embodiments can be constructed without an attachment means (26), and with magnets having sufficient reach out power, thereby enabling concerned embodiment to be securely attached to any part of the targeted sheet except along the bound edge of a sheet or group of sheets such as in a book.
F) Lever plate surfaces do not have to be absolutely flat or smooth. Any of the lever surfaces could have undulations, indentations and even holes on or in them as long as the fulcrum, levers, and reach out power of the magnet permit the magnetic clip to grasp its target securely.
G) The magnetic member levers, armature member levers, and the “firm plate” models can be fabricated to various thicknesses.
H) Thus the scope of the invention should be determined by the appended claims and their legal equivalents, rather than by the examples given.

I claim:

1. A magnetic bookmark releasably securable to a selected position on a page, comprising: a planar magnetic member (20); a planar ferric armature member (22) randomly juxtaposed with respect to longitudinal orientation and magnetically attached to said magnetic member; means for allowing said juxtaposed members to pivotably separate at one side in response to application of a squeezing force at the opposite side of said members;
attachment means (26) hingedly connecting said magnetic member and said armature member; said means for allowing said juxtaposed members to pivotably separate including a firm plate (24) secured to said magnetic member (20) on the side opposite from said armature member (22), said armature member and said firm plate each being of a like dimension and greater than the dimension of said magnetic member, to overlap and provide a fulcrum (44) between said armature member and said firm plate.

2. A magnetic bookmark as claimed in claim 1 wherein said magnet member has these dimensional ranges: diameter ranging from 1.0 mm to 39 mm, and thickness ranging from 0.5 mm to 3.048 mm, and
wherein either or both of said armature member and said firm plate member have these dimensional ranges: length ranging from 7.5 mm to 217 mm, width ranging from 5 mm to 39 mm, and thickness ranging from 0.152 mm to 0.762 mm.

3. A magnetic bookmark as claimed in claim 1 wherein said magnet member has these dimensions: diameter of 1 mm, and thickness of 0.5 mm, and
wherein both said armature member and said firm plate member have these dimensions: Length of 7.5 mm, width of 5 mm, and thickness of 0.178 mm.

4. A magnetic bookmark as claimed in claim 1 wherein said magnet member has these dimensional ranges: length ranging from 5 mm to 22 mm, width ranging from 5 mm to 39 mm, and thickness ranging from 0.762 mm to 3.048 mm,
wherein both said armature member and said firm plate member have these dimensional ranges: length ranging from 7.5 mm to 217 mm, width ranging from 5 mm to 39 mm, and thickness ranging from 0.152 mm to 0.762 mm.

5. A magnetic bookmark as claimed in claim 1 wherein said magnet member has these dimensions: length of 22 mm, width of 39 mm, and thickness of 1.524 mm, and
wherein both said armature member and said firm plate member have these dimensions: Length of 217 mm, width of 39 mm, and thickness of 0.178 mm.

6. A magnetic bookmark releasably securable to a selected position on a page, comprising: a planar magnetic member (20); a planar ferric armature member (22) randomly juxtaposed with respect to longitudinal orientation and magnetically attached to said magnetic member; means for allowing said juxtaposed members to pivotably separate at one side in response to application of a squeezing force at the opposite side of said members;
attachment means (26) hingedly connecting said magnetic member and said armature member; said means for allowing said juxtaposed members to pivotably separate including a beveled edge (60) on one side of said magnetic member.

7. A magnetic bookmark as claimed in claim 6 wherein said magnet member has these dimensional ranges: length ranging from 12 mm to 22 mm, width ranging from 5 mm to 13 mm, and thickness ranging from 0.762 mm to 3.048 mm,
wherein said armature member has these dimensional ranges: length ranging from 14 mm to 26 mm, width ranging from 5 mm to 13 mm, and thickness ranging from 0.152 mm to 0.762 mm.

8. A magnetic bookmark as claimed in claim 6 wherein said magnet member has these dimensions: length of 13 mm, width of 8 mm, and thickness of 1.524 mm, and
wherein said armature member has these dimensions: length of 14 mm, width of 8 mm, and thickness of 0.178 mm.

9. A magnetic bookmark as claimed in claim 6 wherein said magnet member has these dimensions: length of 22 mm, width of 13 mm, and thickness of 1.524 mm, and
wherein said armature member has these dimensions: length of 26 mm, width of 13 mm, and thickness of 0.178 mm.
